(19) United States
(12) Patent Application Publication
(10) Pub. No.: US 2007/0005358 A1
(43) Pub. Date: Jan. 4, 2007

(54) Method for determining a list of hypotheses from a vocabulary of a voice recognition system

(75) Inventors: Sabine Heidenreich, Neubiberg (DE); Niels Kunstmann, Haar (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/476,623

(22) Filed: Jun. 29, 2006

(30) Foreign Application Priority Data
Jun. 29, 2005 (DE) 10 2005 030 380.3

(51) Int. Cl. G10L 15/04

(52) U.S. Cl. 704/251

(57) ABSTRACT

A word to be recognized being spelt out by a user for determining a list of hypotheses from a vocabulary of a voice recognition system. Measures of distance for a similarity between the recognized sequence of letters and entries of the vocabulary of the voice recognition system are determined. One of the following measures is subsequently undertaken: if differences between a number of distance measurements determined are below a predeterminable first value, a request is made by the voice recognition system for the user to continue spelling out the word to be recognized. If a predeterminable measure of distance exceeds a predeterminable second value, a request is made by the voice recognition system for the user to repeat the spelling of the word to be recognized. If differences between a number of measures of distance determined exceed the predeterminable first value and/or a predeterminable measure of distance falls below the predeterminable second value, a list of hypotheses with the entries determined is displayed to the user on a display for selection.

### CROSS REFERENCE TO RELATED APPLICATIONS

This application is based on and hereby claims priority to German Application No. 10 2005 030 380.3 filed on Jun. 29, 2005, the contents of which are hereby incorporated by reference.

### BACKGROUND OF THE INVENTION

The present invention relates to a method and a computer program product for determining a list of hypotheses from a vocabulary of a voice recognition system.

Voice recognition systems, which can recognize individual words or strings of words from a vocabulary which can be specified in advance, are usually used for operating telephones or non safety-relevant components of the equipment of a motor vehicle by spoken commands. Further known examples relate to the use of operation microscopes by the operating physician and the operation of personal computers.

A desired destination can be communicated by voice input for operation of an in-car navigation system for example. Entry of place names represents a particular challenge in such cases. In Germany there are between 70,000 and 80,000 places which might be considered as the destination of a car journey. Because of the lack of context information, resolving this problem with a single-word recognition system represents an immensely great challenge to the technology of the voice recognition system. For this reason, but also for the entry of town names for which the user does not know the correct pronunciation, such as towns in other countries for example, spelling solutions are offered in which the user is asked to speak the first letters of the desired destination.

In such methods the user notifies the navigation system of a destination by spelling it out in letters. On the basis of the sequence of letters recognized, those places for which the starting letters are similar to the recognized letters are determined by the navigation system from the set of all locations. The places are arranged in order of similarity in a selection list which is offered to the user to make a further selection. The user can subsequently enter the desired destination using voice input again or via a keyboard.

The disadvantage of this method is that a large number of entries for the sequence of letters entered will be identified in the vocabulary of the voice recognition system with a corresponding similarity, and the user can only be presented with a very long list of hypotheses for selection. If the user then recognizes that the number of letters which has been spoken by him is evidently not yet sufficient, it only remains for him, by pressing a so-called push-to-talk key, to restart the recognition and speak a larger number of letters.

### SUMMARY OF THE INVENTION

One potential object of the present invention is thus to specify a method for determining a list of hypotheses from a vocabulary of a voice recognition system which is able to be used securely and rapidly by a user.

The inventors propose a method for determining a list of hypotheses from a vocabulary of a voice recognition system in which a word to be recognized is spelt out by a user. Measures of distance for a similarity between the recognized sequence of letters and entries of the vocabulary of the voice recognition system are determined. One of the following measures is subsequently undertaken: If differences between a number of measures of distance determined are below a predeterminable first value, a request is made by the voice recognition system for the user to continue spelling out the word to be recognized. If a predeterminable measure of distance exceeds a predeterminable second value, a request is made by the voice recognition system for the user to repeat the spelling of the word to be recognized: If differences between a number of measures of distance determined exceed the predeterminable first value and/or a predeterminable measure of distance falls below the predeterminable second value, a list of hypotheses with the entries determined is displayed to the user on a display for selection. Thus, in accordance with the method, a heuristic is proposed which controls whether the voice recognition system offers the user a continuation of the spelling-out, a repetition of the spelling-out or a selection list. This means that the user is no longer required to search through a long list of hypotheses and the search thus takes less time. A destination can thus be entered much more quickly and securely by a user since fewer demands or detours are imposed on him by the entry.

In accordance with an advantageous embodiment for determination of measures of distance for a similarity between the recognized sequence of letters and entries of the vocabulary, measures of distance for a similarity between two letters are determined. For the measure of distance the distance values for one letter of the letter sequence and a corresponding letter of the appropriate entry are added up in each case. This is only one option for determining measures of distance for a similarity between the recognized sequence of letters and entries of the vocabulary.

A further option for determining a measure of distance for the similarity between the recognized sequence of letters of the vocabulary and entries of the vocabulary is the use of a Levenshtein distance as the measure of distance, for example with the auxiliary condition that the spelling is allowed to break in the middle of the word.

The Levenshtein distance is a measure for the difference between two character strings as a minimum number of atomic changes which are necessary to convert the first character string into the second character string. Atomic changes are for example the insertion, the deletion and the replacement of an individual letter. Usually costs are assigned to the atomic changes and a measure for the distance or the similarity between two character strings is thus obtained by adding up the individual costs.

In accordance with a further advantageous embodiment, in addition to the list of hypotheses, the letters recognized are also displayed on the display. This enables the user to be advantageously provided with feedback as to how many letters and where necessary with an optional development identified by a predeterminable symbol, the reliability with which a letter has been recognized.

The inventors also propose a computer program product, for determining a list of hypotheses from a vocabulary of a voice recognition system, in which a word to be recognized spelt out by a user is recognized by the program scheduling device. Measures of distance for a similarity between the recognized sequence of letters and entries of the vocabulary of the voice recognition system are determined. Finally one of the following measures is undertaken: If differences between a number of measures of distance determined are below a predeterminable first value, a request is made by the voice recognition system for the user to continue spelling out the word to be recognized. If a predeterminable measure of distance exceeds a predeterminable second value, a request is made by the voice recognition system for the user to repeat the spelling of the word to be recognized. If differences between a number of measures of distance determined exceed the predeterminable first value and/or a predeterminable measure of distance falls below the predeterminable second measure of distance, a list of hypotheses with the entries determined is displayed for the user on a display for selection.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIGS. 1A to 3A are schematic diagrams of three possible alternatives for a sequence of an interaction between a voice recognition system and a user,

FIG. 2 a schematic diagram of a procedural sequence for determining a list of hypotheses from a vocabulary of a voice recognition system.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

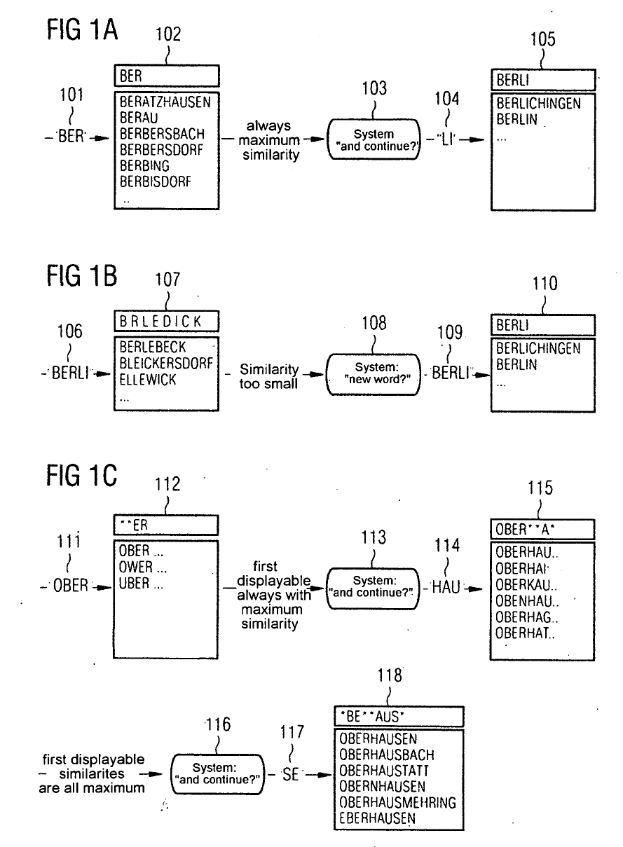

FIG. 1a shows the sequence of an interaction between the voice recognition system and the user, if many words in the list of hypotheses barely differ in their similarity to the detected letter sequence. A user who would like to enter the destination Berlin in this example, speaks the letters “BER” 101. The voice recognition system recognizes the sequence of letters BER and presents a list of hypotheses found with this sequence of letters from the vocabulary 102. Since the individual entries from the list of hypotheses barely differ in their similarities from the sequence of letters, the system asks the user to continue spelling out the word 103. In response the user speaks the additional letters “LI” 104 into the system. On the basis of the sequence of letters BERLI recognized the voice recognition system compiles a new list of hypotheses 105 which is significantly shorter and thereby easier to follow for the user.

FIG. 1b shows a possible sequence of an interaction between the voice recognition system and the user where no individual entry from the list of hypotheses has a sufficient similarity to a recognized sequence of letters. A user wishing to enter Berlin as the destination speaks the sequence of letters “BERLI” 106 into the system. The voice recognition system recognizes the sequence of letters BRLEDICK and, from this incorrectly recognized sequence of letters, presents a derived list of hypotheses 107. It is established by the system that the similarity of the entry from list of hypotheses with the best measure of similarity is still not sufficient. Thus the request is made by the voice recognition system to the user to repeat the entry of the sequence of letters 108. The user enters the sequence of letters “BERLI” 109 into the system once more. The system assembles a new and much shorter list of hypotheses 110 only on the basis of the correctly recognized sequence of letters BERLI. This enables an incorrectly recognized sequence of letters to be corrected, with the process also being able to be expanded by including an acoustic accuracy of the letter recognition in order to detect misrecognition because of strong background noise or surrounding noises at an early stage.

FIG. 1c shows the sequence of an interaction between the voice recognition system and the user when very many different letters have a high similarity to the recognized sequence of letters. A user wishing to travel to Oberhausen speaks the sequence of letters “OBER” 111 into the system. The voice recognition system identifies for the letter O spoken the phonetically similar letters O and U and for the letter B spoken the phonetically similar letters B and W. This is indicated by the system by an asterisk symbol 112. As a result of the great similarity between the entries in the list of hypotheses the voice recognition makes a request for the spelling to be continued 113. The user then speaks the sequence of letters “HAU” into the system 114. The additional information now allows the system to uniquely identify the letters O and B whereas the letters R, H and U are now no longer uniquely recognized 115. Once again the user is requested to continue the spelling 116. After entry of the letters “SE” 117 by the user a list of hypotheses 118 is now assembled by the system, containing as its first entry the desired destination.

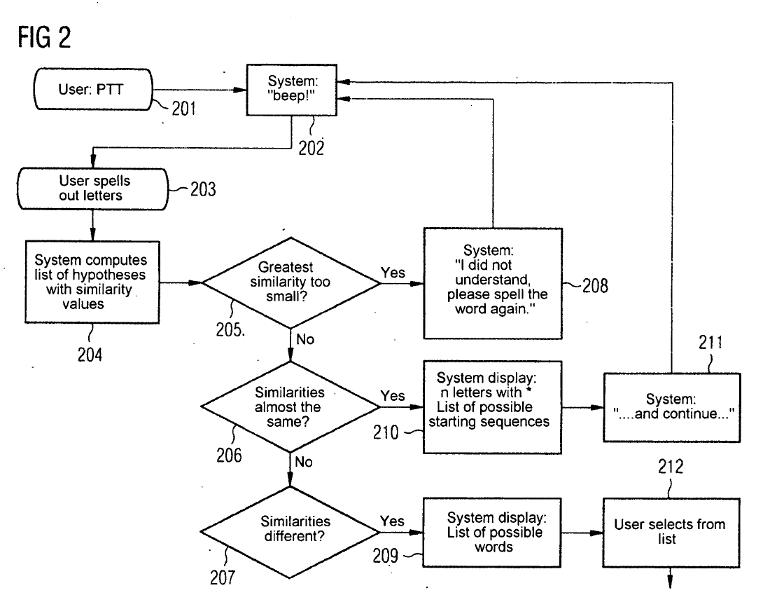

As a further exemplary embodiment FIG. 2 shows a possible execution sequence of a method for determining a list of hypotheses from a vocabulary of a voice recognition system. A user starts the letter recognition 201 either by pressing a push-to-talk button in the corresponding input dialog or the entry is produced directly by the previous dialog step. The voice recognition system signals for example that it is ready to accept a sequence of letters by a “beep” 202. The user spells the first letters of the desired destination or the desired destination town 203. The invention is not just restricted to the voice entry of navigation destinations but can be used for any task involving spelling out words. This could for example be the case with an address book for a mobile communication device. The system computes a list of hypotheses of words of the vocabulary together with their similarities to the recognized sequence of letters 204. If the similarity of the best hypothesis is too small although the purely acoustic letter recognition was sufficient the entry is incorrect, possibly as a result of strong background noises or of the passenger speaking, or the recognition was deficient for another reason 205. If the similarities of very many hypotheses are almost the same the number of letters spoken are not sufficient 206. If the individual hypotheses differ in the similarities to the recognized sequence of letters to a sufficient degree the area of a hypothesis as regards their similarity to the recognized sequence is therefore very sparse and the system decides that the number of letters is sufficient 207.

If the similarities are too small a new start of the spelling process is suggested to the user 208. If the difference between the similarities of individual entries its sufficient the system displays the conventional selection list 209. Optionally the system shows in the first line the hypothesized sequence of letters. Letters which were not uniquely recognized, or for which in the entries of the vocabulary for this position a number of similar letters exist, are displayed by a special symbol “*”. In this example the best recognized initial sequences are presented in the list 210. If the similarities between the entries of the list of hypotheses are almost the same, the system asks the user to continue with the spelling 211. From the list of hypotheses shown at the end of the process the user selects his desired destination from the list in a conventional manner 212, either by voice entry or by tactile selection.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

What is claimed is:

1. A method for determining a list of hypotheses from a vocabulary of a voice recognition system, in which a word to be recognized is spelt out by a user, comprising:
determining measures of distance for a similarity between a recognized sequence of letters and entries of the vocabulary of the voice recognition system;
if differences between the measures of distance are below a predetermined first value, then making a request by the voice recognition system for the user to continue spelling out the word to be recognized;
if the measures of distance exceed a predetermined second value, then making a request by the voice recognition system for the user to repeat the spelling of the word to be recognized; and
if differences between the measures of distance exceed the predetermined first value and/or are less than or equal to the predetermined second value, then displaying on a display a list of hypotheses having the entries that are similar to the recognized sequence of letters.

2. The method in accordance with claim 1, wherein to determine measures of distance for a similarity between the recognized sequence of letters and entries of the vocabulary, distance values for a similarity of two letters are determined, for the measure of distance the distance values for one letter of the sequence of letters and a corresponding letter of an appropriate vocabulary entry are added up.

3. The method in accordance with claim 2, wherein the distance values relate to a phonetic similarity between the two letters.

4. The method in accordance with claim 1, wherein the measures of distance are determined using a Levenshtein measure of distance.

5. The method in accordance with claim 1, wherein in addition to displaying the list of hypotheses, the recognized sequence of letters is also displayed.

6. The method in accordance with claim 5, wherein letters not uniquely identified or letters for which there are a plurality of similar letters, are identified by a predetermined symbol on the display.

7. The method in accordance with claim 1, wherein the request for the user to continue spelling and the request for the user to repeat the spelling are made by the voice recognition system in acoustic and/or visual form.

8. The method in accordance with claim 1 wherein if a number of hypotheses in the list of hypotheses exceeds a third value, a request is made to the user by the voice recognition system to continue the spelling-out the word to be recognized.

9. The method in accordance with claim 3, wherein the measures of distance are determined using a Levenshtein measure of distance.

10. The method in accordance with claim 9, wherein in addition to displaying the list of hypotheses, the recognized sequence of letters is also displayed.

11. The method in accordance with claim 10, wherein letters not uniquely identified or letters for which there are a plurality of similar letters, are identified by a predetermined symbol on the display.

12. The method in accordance with claim 11, wherein the request for the user to continue spelling and the request for the user to repeat the spelling are made by the voice recognition system in acoustic and/or visual form.

13. The method in accordance with claim 12 wherein if a number of hypotheses in the list of hypotheses exceeds a third value, a request is made to the user by the voice recognition system to continue the spelling-out the word to be recognized.

14. A computer readable medium containing a computer program, which when executed by a computer, causes the computer to perform a method for determination of a list of hypotheses from a vocabulary of a voice recognition system, in which a word to be recognized is spelt out by a user, the method comprising:
determining measures of distance for a similarity between a recognized sequence of letters and entries of the vocabulary of the voice recognition system;
if differences between the measures of distance are below a predetermined first value, then making a request by the voice recognition system for the user to continue spelling out the word to be recognized;
if the measures of distance exceed a predetermined second value, then making a request by the voice recognition system for the user to repeat the spelling of the word to be recognized; and
if differences between the measures of distance exceed the predetermined first value and/or are less than or equal to the predetermined second value, then displaying on a display a list of hypotheses having the entries that are similar to the recognized sequence of letters.

15. A method for presenting a list of potential word matches from a vocabulary of a voice recognition system in which a user audibly spells a word to be recognized, comprising:
before spelling of the word is complete, determining if a sequence of letters recognized is sufficiently similar to letters of words from the vocabulary;
if the sequence of letters recognized is not sufficiently similar, then audibly asking the user to respell the word;
before spelling of the word is complete, preparing a list of potential word matches that have letters corresponding to the sequence of letters recognized;
if the list of potential word matches is not sufficiently short, then audibly asking the user to continue spelling; and
if the list of potential word matches is sufficiently short, then presenting the list to the user.
